(19) United States
(12) Patent Application Publication
(10) Pub. No.: US 2009/0027367 A1
(43) Pub. Date: Jan. 29, 2009

(54) CIRCUIT OF LIQUID CRYSTAL DISPLAY DEVICE FOR GENERATING COMMON VOLTAGES AND METHOD THEREOF

(75) Inventors: HSUAN CHEN LIU, TAIPEI COUNTY (TW); HSU HO WU, TAIPEI COUNTY (TW); CHIA HUA YU, TAIPEI COUNTY (TW); CHUN CHIN TSENG, TAIPEI COUNTY (TW); KUN CHENG LEE, TAIPEI COUNTY (TW); YI TSE LIN, TAIPEI COUNTY (TW)

Correspondence Address: WPAT, PC;INTELLECTUAL PROPERTY ATTORNEYS, 2030 MAIN STREET, SUITE 1300, IRVINE, CA, 92614, US

(73) Assignee: HANNSTAR DISPLAY CORPORATION, TAIPEI COUNTY (TW)

(21) Appl. No.: 12/174,260

(22) Filed: Jul. 16, 2008

(30) Foreign Application Priority Data
Jul. 27, 2007 (TW) 096127433

(51) Int. Cl. G06F 3/038

(52) U.S. Cl. 345/204

(57) ABSTRACT

A circuit of a liquid crystal display device for generating common voltages comprises an initial voltage source, an inverter, and a panel common voltage input port. The initial voltage source generates an initial voltage. The voltage signal from the panel common voltage input port passes through the inverter to become a compensation voltage. The initial voltage is compensated by the compensation voltage to result in a compensated common voltage. The compensated common voltage supplies the panel of the liquid crystal display device.

### BACKGROUND OF THE INVENTION

(A) Field of the Invention

The present invention relates to a circuit of a liquid crystal display (LCD) device for generating common voltages and a method thereof, and more particularly, to a circuit for generating common voltages and a method thereof to stabilize the common voltages of the LCD panel.

(B) Description of the Related Art

A conventional liquid crystal display device comprises an array substrate with a plurality of pixel electrodes, a color filter substrate with common electrodes, and the liquid crystal disposed between the two substrates. If a voltage is applied between the pixel electrode and common electrode, the potential difference in the pixel electrode and common electrode will twist the direction of the liquid crystal molecules. The pixel electrodes are arranged in a matrix of pixels and connected to the thin film transistor (TFT) devices. The thin film transistor devices selectively transmit the data signal voltages from the data lines in response to the gate signals from the gate lines.

In such a liquid crystal display device, a voltage is simultaneously applied to both a pixel electrode and common electrode such that an electric field is generated in the liquid crystal layer. The strength of the electric field can be controlled to adjust the transmittance ratio of light passing through the liquid crystal layer, thereby showing predetermined images. In order to prevent image deterioration resulting from prolonged existence of unidirectional electric field in the liquid crystal layer, polarity inversion can be applied to the data voltages and common voltages of each frame, each pixel column, each pixel row or each pixel during each vertical scanning period.

However, as the resolution of the liquid crystal display device is improved (for example: from SXGA to WUWGA+ etc.), capacitance coupling effects in the pixel areas become more significant, and should be taken into account when designing the panels. In general, increase of the capacitance coupling effect strongly affects the voltages applied to the pixel electrodes, and results in an imbalance of voltage drops across an area of the LCD panel, causing a greenish, reddish, or bluish hue to the display.

FIGS. 1A-1B are illustrations showing a conventional liquid crystal display device with a greenish hue resulting from voltage shifts on common electrodes. As shown in FIG. 1A, the practical voltage V_{com}′ on a common electrode is higher than the presetting voltage V_{com} because of the capacitance coupling effect. Since the green (G) subpixel is disposed between the red (R) and blue (B) subpixels, the greenish hue shown on the display results from the excessive proportion of the green to red, green and blue. As shown in FIG. 1B, when the polarity of a pixel is reversed, the practical voltage on the common electrode is V_{com}′ and is lower than the presetting voltage V_{com} because of the capacitance coupling effect. Similarly, a greenish hue is shown on the display because of the excessive proportion of the green to red, green and blue.

In general, there are two major methods to resolve the above-mentioned issue. One is to lower the impedance of the common electrode (ITO transparent electrode) on the color filter substrate, thereby improving the balancing recovery ability of the voltage V_{com}′; the other is to increase the contact area of the Au transfer points of the common electrode, thereby improving the stability of the voltage V_{com}′. However, these two solutions will not be able to resolve the above-mentioned issue for large dimension liquid crystal display devices. Due to limitations in the characteristics of the ITO material, the resistance of the common electrode cannot be reduced indefinitely in term of the impedance. In contrast, increasing the Au transfer contacts will increase the time for manufacturing and lower the production capability per unit time. For large dimension liquid crystal display devices, the number of Au transfer contacts cannot be increased without limitation. In this regard, it appears that the voltage V_{com}′ cannot be stabilized across the entire substrate.

### SUMMARY OF THE INVENTION

One aspect of the present invention provides a circuit of a liquid crystal display device for generating common voltages and a method thereof, wherein the common voltage on a panel is inverted as a compensation voltage to feed back to the common electrodes of the panel. This dynamic compensation method will supply the compensation voltage in real-time to the common electrodes. The compensation voltage immediately results in that the voltage on the common electrodes is changed accordingly. Therefore, the voltage across each area of the panel remains stable to avoid showing an image with color bias.

In view of the above aspect, the present invention provides a circuit of a liquid crystal display device for generating common voltages comprising an initial voltage source, an inverter, and a panel common voltage input port. The initial voltage source generates an initial voltage. The voltage applied to the panel common voltage input port passes through the inverter to serve as a compensation voltage. The compensation voltage compensates the initial voltage to result in a common voltage. The resulting common voltage supplies the panel of the liquid crystal display device.

The present invention further provides a method of generating common voltages for a liquid crystal display device that comprises the steps of generating an initial voltage and deriving a common voltage from the panel of a liquid crystal display device; inverting the common voltage to compensate the initial voltage; and supplying the compensated initial voltage to the panel.

### BRIEF DESCRIPTION OF THE DRAWINGS

The objectives and advantages of the present invention will become apparent upon reading the following description and upon reference to the accompanying drawings in which:

FIGS. 1A-1B are illustrations showing a conventional liquid crystal display device with a greenish hue resulting from voltage shifts on common electrodes;

FIG. 2 is an illustration showing a common voltage generating circuit in accordance with a first embodiment of the present invention;

FIG. 3 is an illustration showing a common voltage generating circuit in accordance with a second embodiment of the present invention; and

FIGS. 4A-4B are illustrations showing a common voltage generating circuit in accordance with a third embodiment of the present invention.

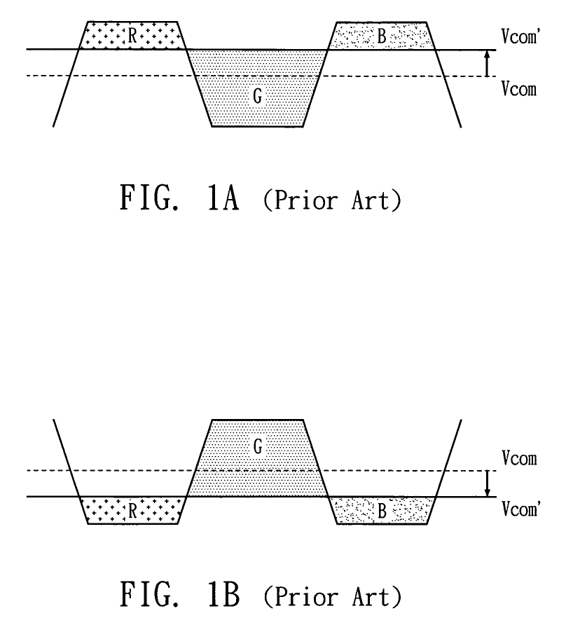

### DETAILED DESCRIPTION OF THE INVENTION

In a liquid crystal display device, a common electrode is provided on a color filter substrate such that electric fields can be generated between the common electrode and pixel electrodes on the array substrate to control the rotation directions of liquid crystal molecules. The common voltage on the common electrode is given as V_{com}^{CF}. Furthermore, the array substrate also has a common electrode thereon to provide a reference voltage for storage capacitors on the array substrate. The common voltage on the common electrode is given as V_{com}^{AA}.

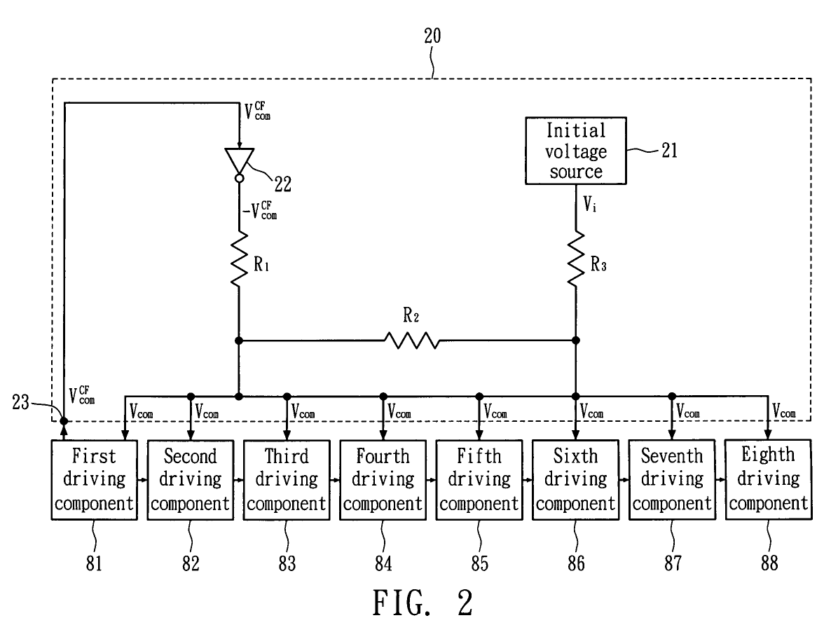

FIG. 2 is a schematic diagram of a common voltage generating circuit in accordance with the first embodiment of the present invention. In the present embodiment, the common electrode of the color filter substrate and the common electrode of the array substrate short to each other, and the two common electrodes are disposed on the CF substrate and the array substrate repectively. The common voltage generating circuit 20 comprises an initial voltage source 21, an inverter 22 and a panel common voltage input port 23. The initial voltage source 21 generates an initial voltage Vᵢ, where the initial voltage Vᵢ passes through from a first driver 81 to an eighth driver 88 for supplying the common electrode of the color filter substrate and the common electrode of the array substrate (not shown). After the initial voltage Vᵢ is fed into the circuit, the common electrode on the color filter substrate has a common voltage of V_{com}^{CF} due to the capacitance coupling effect of the panel. Subsequently, the common voltage V_{com}^{CF} becomes a compensation voltage −V_{com}^{CF} after passing through the inverter 22. The compensation voltage −V_{com}^{CF} compensates the initial voltage to result in a dynamic common voltage V_{com}. The dynamic common voltage V_{com} is supplied to the common electrodes of the color filter substrate and the common electrode of the array substrate. In addition, R₁, R₂, and R₃ in FIG. 2 represent the resistors.

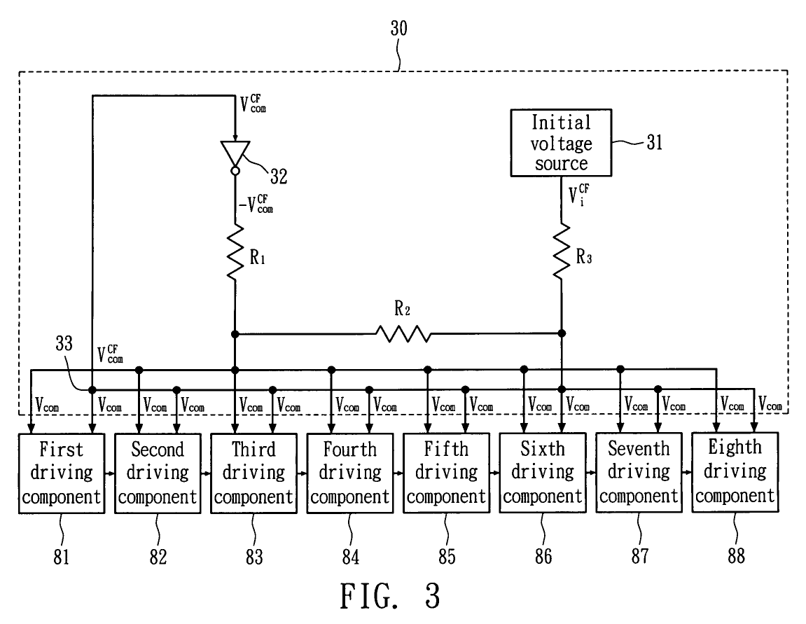

The embodiment of FIG. 2 illustrates the short circuit between the common electrode of the color filter substrate and the common electrode of the array substrate. However, in order to avoid the interference between the voltage signals on the two common electrodes, the embodiment of FIG. 3 further disconnects the two common electrodes to form an open circuit, and individually supplies the same common voltages V_{com} to the two common electrodes.

FIG. 3 is a schematic diagram of a common voltage generating circuit in accordance with the second embodiment of the present invention. A common voltage generating circuit 30 similarly comprises an initial voltage source 31, an inverter 32, and a panel common voltage input port 33. The initial voltage source 31 generates the initial voltage Vᵢ, where the initial voltage Vᵢ passes through from the first driver 81 to the eighth driver 88 for supplying the common electrode of the color filter substrate. After the initial voltage Vᵢ is fed into the circuit, the common electrode of the color filter substrate has a common voltage of V_{com}^{CF} due to the capacitance coupling effect of the panel. Subsequently, the common voltage V_{com}^{CF} becomes a compensation voltage −V_{com}^{CF} after passing through the inverter 32. The compensation voltage −V_{com}^{CF} compensates the initial voltage to result in a dynamic common voltage V_{com}, and the dynamic common voltage V_{com} is supplied to the two common electrodes of the panel respectively.

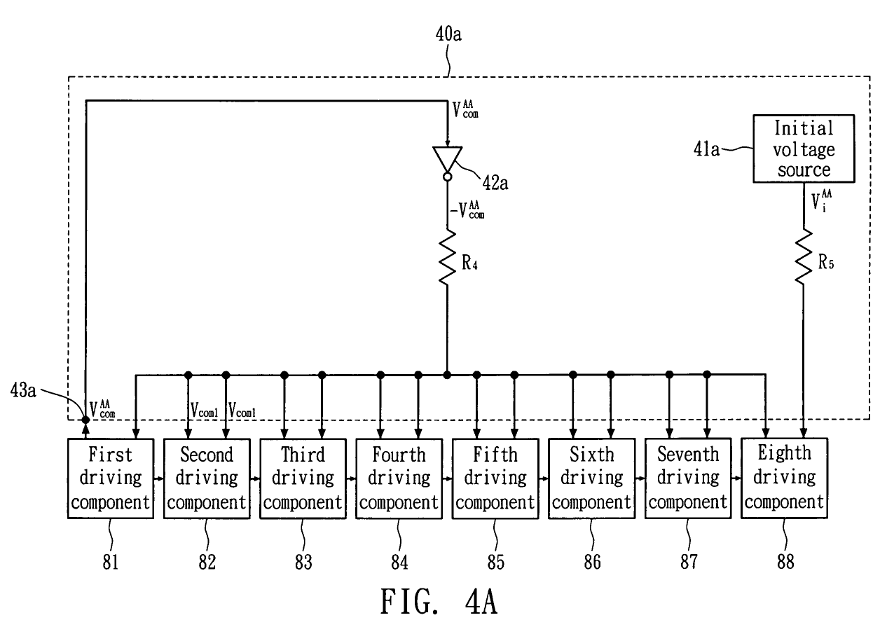

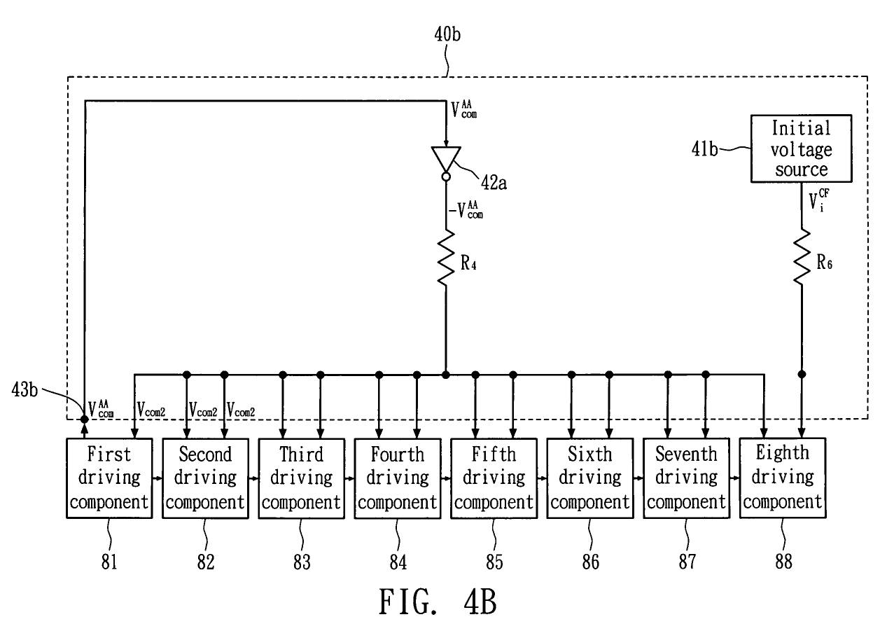

Compared with the second embodiment in FIG. 3, FIGS. 4A-4B illustrate the two different common voltage generating circuits 40a and 40b each generating a common voltage to supply the common electrode of the color filter substrate and the common electrode of the array substrate, respectively.

FIGS. 4A-4B are the circuit diagrams of the generation of the common voltage according to the third embodiment of the present invention. As shown in FIG. 4A, a common voltage generating circuit 40a supplying the common electrode of an array substrate also comprises an initial voltage source 41a, an inverter 42a, and a common voltage input port 43a serving as the input terminal of the common electrode of the array substrate. The initial voltage source 41 a generates an initial voltage Vᵢ^{AA}, where the initial voltage Vᵢ^{AA} passes through from the first driver 81 to the eighth driver 88 for supplying the common electrode of the array substrate. After the initial voltage Vᵢ^{AA} is fed into the circuit, the common electrode of the array substrate has a common voltage of V_{com}^{AA} due to the capacitance coupling effect of the panel. Subsequently, the common voltage V_{com}^{AA} becomes a compensation voltage −V_{com}^{AA} after passing through the inverter 42a. The compensation voltage −V_{com}^{AA} compensates the initial voltage to result in a dynamic common voltage V_{com1}, and the common voltage V_{com1} is supplied to the common electrode of the array substrate or a color filter substrate. In addition, R₄ and R₅ in FIG. 4A represent the resistors.

As shown in FIG. 4B, the common voltage generating circuit 40b supplying the common electrode of the color filter substrate also comprises an initial voltage source 41b, an inverter 42a (shared with the common voltage generating circuit 40a), and a common voltage input port 43b serving as the input terminal of the common electrode of a color filter substrate. The initial voltage source 41b generates the initial voltage Vᵢ^{CF}, where the initial voltage Vᵢ^{CF} passes through from the first driver 81 to the eighth driver 88 for supplying the common electrode of the color filter substrate. After the initial voltage Vᵢ^{CF} is fed into the circuit, as the panel has a greater capacitance coupling effect on the common electrode of the array substrate, the common voltage V_{com}^{AA} derived from the array substrate serves as a feedback signal. The common voltage V_{com}^{AA} becomes a compensation voltage −V_{com}^{AA} after passing through the inverter 42a. The compensation voltage −V_{com}^{AA} compensates the initial voltage to result in a dynamic common voltage V_{com2}, and the common voltage V_{com2} is supplied to the common electrode on the color filter substrate or the array substrate. In addition, R₅ and R₆ in FIG. 4B represent the resistors.

The above-described embodiments of the present invention are intended to be illustrative only. Those skilled in the art may devise numerous alternative embodiments without departing from the scope of the following claims.

What is claimed is:

1. A circuit of a liquid crystal display device for generating common voltages, comprising:
an initial voltage source generating an initial voltage;
a panel common voltage input port receiving a common voltage detected from a common electrode of a panel; and
an inverter inverting the common voltage into a compensation voltage;
wherein the compensation voltage compensates the initial voltage to have a compensated common voltage for being applied to the panel.

2. The circuit of a liquid crystal display device for generating common voltages of claim 1, wherein the compensated common voltage supplies a common electrode of a color filter substrate of the panel.

3. The circuit of a liquid crystal display device for generating common voltages of claim 2, wherein the compensated common voltage further supplies the common electrode of an array substrate of the panel.

4. The circuit of a liquid crystal display device for generating common voltages of claim 3, wherein the common electrode of the color filter substrate and the common electrode of the array substrate are included in two separate circuits, and are disposed on the color filter substrate and the array substrate respectively.

5. The circuit of a liquid crystal display device for generating common voltages of claim 1, wherein the compensated common voltage supplies a common electrode of a color filter substrate of the panel and a common electrode of an array substrate of the panel.

6. The circuit of a liquid crystal display device for generating common voltages of claim 5, wherein the common electrode of the color filter substrate and the common electrode of the array substrate short to each other.

7. A circuit of a liquid crystal display device for generating common voltages, comprising:
a first initial voltage source generating a first initial voltage;
a second initial voltage source generating a second initial voltage;
a first common voltage input port receiving a first common voltage detected from a common electrode of an array substrate;
a second common voltage input port receiving a second common voltage detected from a common electrode of a color filter substrate; and
an inverter inverting the first common voltage into a first compensation voltage, wherein the first compensation voltage compensates the first initial voltage to have a first compensated common voltage and the inverter inverts the second common voltage into a second compensation voltage;
wherein the second compensation voltage compensates the second initial voltage to have a second compensated common voltage.

8. The circuit of a liquid crystal display device for generating common voltages of claim 7, wherein the first compensated common voltage supplies the common electrode of the array substrate.

9. The circuit of a liquid crystal display device for generating common voltages of claim 7, wherein the second compensated common voltage supplies the common electrode of the color filter substrate.

10. The circuit of a liquid crystal display device for generating common voltages of claim 9, wherein the common electrode of the color filter substrate and the common electrode of the array substrate are included in two separate circuits, and are configured on the array substrate.

11. A method of generating common voltages for a liquid crystal display device, comprising the steps of:
generating an initial voltage;
deriving a common voltage of a panel from a liquid crystal display device;
inverting the common voltage to compensate the initial voltage for generating a compensated common voltage; and
supplying the compensated common voltage to the panel.

12. The method of generating common voltages for a liquid crystal display device of claim 11, wherein the common voltage is a voltage detected from a common electrode of a color filter substrate of the panel.

13. The method of generating common voltages for a liquid crystal display device of claim 11, wherein the common voltage is a voltage detected from a common electrode of an array substrate of the panel.

14. The method of generating common voltages for a liquid crystal display device of claim 13, wherein the common voltage supplies the common electrode of the array substrate or the color filter substrate.

15. The method of generating common voltages for a liquid crystal display device of claim 12, wherein the common voltage supplies a common electrode of a color filter substrate of the panel and a common electrode of an array substrate of the panel.

16. The method of generating common voltages for a liquid crystal display device of claim 15, wherein the common electrode of the color filter substrate and the common electrode of the array substrate short to each other.
